(19) United States
(12) Patent Application Publication
(10) Pub. No.: US 2013/0130125 A1
(43) Pub. Date: May 23, 2013

(54) CROSS-LINKED BATTERY ELECTRODE SEPARATOR

(71) Applicant: Ray L. Hauser, Boulder, CO (US)

(72) Inventor: Ray L. Hauser, Boulder, CO (US)

(21) Appl. No.: 13/473,458

(22) Filed: May 16, 2012

Related U.S. Application Data
(60) Provisional application No. 61/486,499, filed on May 16, 2011.

(51) Int. Cl. H01M 2/16

(52) U.S. Cl. CPC H01M 2/16
USPC 429/249; 427/77

(57) ABSTRACT

A cross-linked microporous polymeric battery electrode separator membrane is described. Such membranes, which would otherwise be soluble above a particular, generally high temperature in selected battery electrolyte systems, once at least in part cross-linked, swell in the electrolyte at the particular higher temperature instead of dissolving. When the membrane separators are restrained between solid electrodes in a battery, the separator cannot increase in bulk volume, and the swelling occurs within the pores with the pore volume decreasing from its original bulk volume. The drop in pore volume causes the battery current density to drop, thereby reducing the heat generation within the hot area of the battery. This process provides a measure of safety against overheating and fires, and the battery is capable of continued usage if the overheating is localized.

### CROSS-REFERENCE TO RELATED APPLICATIONS

The present application claims the benefit of U.S. Provisional Patent Application No. 61/486,499 for “Superior Battery Electrode Separator” which was filed on 16 May, 2011, the entire contents of which is hereby specifically incorporated by reference herein for all that it discloses and teaches.

### FIELD OF THE INVENTION

The present invention relates generally to polymeric membranes and, more particularly to membranes for insulating electrodes in batteries and other electrical devices.

### BACKGROUND OF THE INVENTION

Separator membranes are required to insulate the anode and cathode electrodes in storage batteries during the full range of operating conditions—from low temperature to high temperature, and across a wide range of charging and discharging rates. The membranes are necessarily thin and microporous to maximize the flow of ions during charging and discharging of the batteries. Highest current densities and temperatures are usually experienced during rapid charging of these batteries.

Lithium ion batteries are noted for their superior performance, except for rare occurrences of shorts or other conditions that can cause overheating, overpressure and fires.

Conventional separators for lithium ion batteries are constructed from non-crosslinked polyolefins or fluoroplastics. Polyolefin separators have been found to respond adversely in the presence of electrolyte solvents at temperatures above 60° C. For example, when investigated for restrained shrinkage characteristics by placement within an embroidery hoop and exposed for 1 h to hot propylene carbonate, polyolefins have been observed to develop pinholes or splits.

A claimed safety feature for certain commercial polyolefin separators for lithium ion batteries is the use of a thermoplastic additive that is expected to melt and form an electrically insulating film at a melting temperature below that of the separator. This so-called “shut-down separator” has failed many tests in batteries where overheating continued to the point of starting fires. The inherent difficulty with this process is the low surface tension forces of the thermoplastic additive, which have little thermodynamic motive for forming a film to displace the electrolyte that has previously been in contact with the principal polymer of the separator.

Conventional fluoroplastic separators (polyvinylidene fluoride (PVDF) and/or copolymers of vinylidene fluoride and hexafluoropropylene) have been observed to gel and dissolve completely in bulk propylene carbonate at temperatures in the range of 60° C. When confined between the electrodes of a lithium ion battery where there is a limited amount of solvent, these polymers may become gels, and may continue to perform at somewhat higher temperatures. However, they are structurally weak gels having little resistance to growth of penetrating conducting dendrites that sometimes occur in batteries.

Some lithium ion battery fires have been attributed to the presence of small, conductive particulates, such as trimmings from foil current collectors. Such particles can be pressed into electrode separators by the thermal and electrode growth factors experienced in normal battery operation, and may cause high local current density leading to hot spots. Separators that are softened or weakened at high temperatures are susceptible to such cut-through effects.

Microporous membranes made of alternative polymers such as polysulfones, and acrylonitrile-butadiene-styrene are also known to be soluble in hot electrolyte solvents such as propylene carbonate.

### SUMMARY OF THE INVENTION

Embodiments of the present invention overcome the disadvantages and limitations of the prior art by providing a microporous battery electrode separator having safer performance at higher battery temperatures.

Another object of embodiments of the present invention is to provide a microporous battery electrode separator which does not dissolve in electrolytes used in batteries.

Still another object of embodiments of the invention is to provide a microporous battery electrode separator which does not melt at high battery temperatures.

Yet another object of embodiments of the invention is to provide a microporous fluoropolymer battery electrode separator having safer performance at higher battery temperatures.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the microporous lithium ion battery electrode separator hereof, includes: a cross-linked polymer capable of swelling without dissolving at least 1% by volume when unrestrained and exposed to battery electrolyte at temperatures above the normal operating temperature of said battery.

In another aspect of the invention, and in accordance with its objects and purposes, the method for generating a battery electrode separator, hereof includes the steps of: forming a solution of a fluoropolymer or fluoropolymer copolymer, a solvent for the fluoropolymer or fluoropolymer copolymer, a miscible non-solvent for the fluoropolymer or fluoropolymer copolymer; and cross-linking composition; casting the solution onto a substrate; removing the non-solvent and solvent such that a microporous polymer is generated; and heating the microporous polymer such that cross-linking takes place.

Benefits and advantages of the present invention include, but are not limited to, providing lithium ion batteries having a significant measure of safety against overheating and fires, and capable of continued usage when batteries experience only local overheating, by reducing the effects of local dendrites or particulate contaminants that may cause hot spots in the battery. Electronic or thermal controls on such batteries may detect these changes (from reduction in battery current or higher battery temperature) to provide instrumental warning of an impending problem that needs to be addressed.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of portions of macromolecules of a dry polymer overlapping in triangular pattern, for purposes of illustration, shown forming a void or pore within the triangle.

FIG. 2 depicts the same triangular pattern as shown in FIG. 1 for three portions of polymer macromolecules having the same overlapping portions, but which are now cross-linked at these locations as marked with Xs, the cross-linked polymer having been immersed in a hot solvent resulting in each molecular segment being swollen, thereby reducing the size of the pore with a corresponding reduction in space for free ion flow, yielding a decrease of current density.

### DETAILED DESCRIPTION OF THE INVENTION

Briefly, the embodiments of the present invention includes cross-linked microporous polymeric membrane lithium ion battery electrode separators. Such membranes, which would otherwise be soluble or meltable above a particular, generally high temperature in selected battery electrolyte systems, once at least in part cross-linked, swell in the electrolyte at the particular higher temperature instead of dissolving. Historically, polymer swelling has been considered to be a disadvantage. Rubber tires and rubber gaskets are sensitive to gasoline and aromatic hydrocarbons, and contact with these chemicals can swell rubber many-fold. The larger volume may manifest itself by a gasket swelling out of its compressive confinement, and/or a weakening that may result in tearing and mechanical failure. However, when the cross-linked membrane separators of the present invention are restrained between solid electrodes and other structures in a battery, the separators can no longer increase in bulk volume, and the swelling occurs into the pore volume to decrease this volume from its original volume. The drop in pore volume will cause the battery current density to drop, thereby reducing the heat generation within the hot area of the battery.

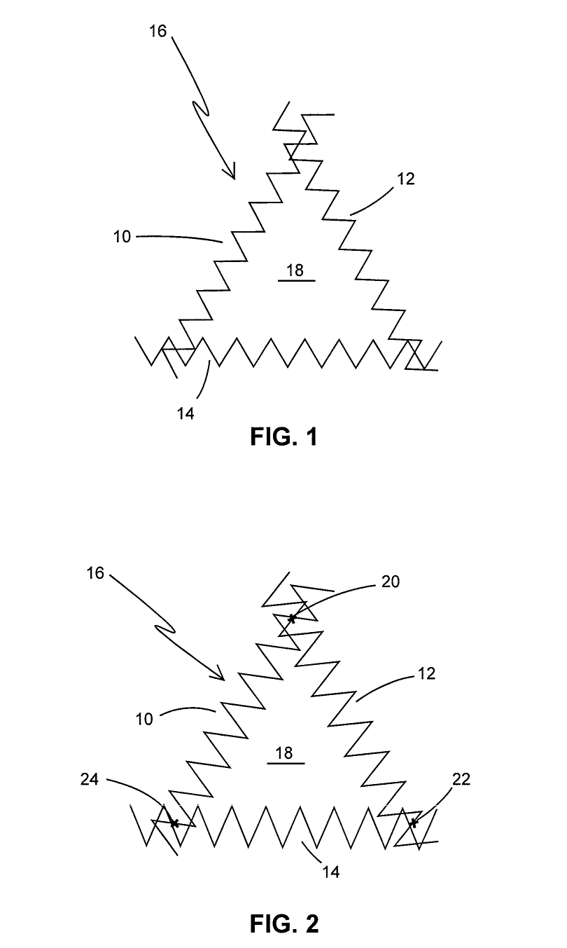

Reference will now be made in detail to the present embodiments of the invention, examples of which are illustrated in the accompanying drawings. In the FIGURES, similar structure will be identified using identical reference characters. It will be understood that the FIGURES are presented for the purpose of describing particular embodiments of the invention and are not intended to limit the invention thereto. Turning first to FIG. 1, a schematic representation of portions of macromolecules, 10, 12, and, 14 (only the intersecting portions of the macromolecules are shown; however, each of the three macromolecules may extend significantly, and in three dimensions), of a dry polymer overlapping in triangular pattern, 16, for purposes of illustration, is shown. Void or pore, 18, is formed within triangle 16. Polymer molecules are generally disposed in either a helical pattern or in a folded pattern, the folded pattern being depicted for simplicity. FIG. 2 depicts the same pattern of three portions of polymer molecules 10, 12 and 14, having the same overlapping regions which are now cross-linked at locations, 20, 22, and, 24, as marked with Xs. The cross-linked polymer is immersed in a hot solvent, and each molecular segment is swollen within a constrained environment. The solvent molecules are absorbed within the folds of each of the molecular segment, which are shown to be larger in FIG. 2 than in FIG. 1. Since the polymeric strands are cross-linked, they cannot expand by sliding past one another, and the size of pore 18 is seen to be considerably smaller. Such pore size reduction in a microporous battery separator membrane reduces the space for free ion flow, yielding a decrease current density.

Hot, swollen cross-linked membranes were found to have physical durability and coherence, in contrast to gel formation of non-crosslinked membranes. The theory for cross-linked membranes is based upon the large thermodynamic forces of swelling of polymers as caused by certain electrolytes at high temperatures. See, e.g., Ray L. Hauser et al., “Swelling of Silicone Elastomers,” Indust. and Eng. Chem. 48, 1202 (1956).

Battery separators made of polyvinylidene fluoride and/or its copolymers, such as vinylidene and hexafluoropropylene, have effective chemical stability for use in lithium ion batteries. These polymers are resistant to decomposition at high voltages, and are non-flammable. Beneficially, their thermal decomposition products are reasonable fire retardants. Polyvinylidene fluoride polymers can be fabricated with high porosity, as described in U.S. Pat. No. 8,147,732 for “Highly Microporous Polymers And Methods For Producing And Using The Same,” which issued to Kirby W. Beard on Apr. 3, 2012, said patent being hereby incorporated by reference herein in its entirety for all that it discloses and teaches. However, these polymers melt/dissolve in carbonate electrolytes, which are conventionally used as electrolytes in lithium ion batteries, at about 60° C.

Embodiments of the present invention provide effective microporosity for certain polymers (EXAMPLE 2, hereinbelow, discusses the preparation of cross-linked, microporous polysulfone) by using a gelling agent added to a polymer solution in a solvent/non-solvent mixture. The gelling agent may be a mineral, such as fumed silica, alumina, or bentonite. Commercially available fumed silicas, such as Cab-O-SiI, and Aerosil are particularly effective. Fumed silicas are available with particle sizes ranging from about 7 nm to approximately 14 nm. Cab-O-Sil M5 is a relatively pure silica without surface treatment. Cab-O-Sil 610 is a similar product with treatment using a silane coupling agent; Cab-O-Sil 720 has a more extensive treatment using a silane coupling agent, appropriate for gelling solvents having less polarity. The gelling agent generates a thixotropic solution when added in bulk volume approximately equal to that of the solution. It provides high viscosity and, when cast in a thin film, has sufficient strength to prevent collapse of the film and maintain porosity between the silica particles while the solvent is evaporating or otherwise being removed (as occurs in a normal lacquer type formulation).

As will be described in more detail in EXAMPLE 1, hereinbelow, the separator membranes of the present invention are cross-linked, and the thickness of a polyvinylidene fluoride (PVDF) membrane was noted to increase from about 21.6 μm (when dry) to approximately 22.9 μm after heating to about 80° C. in propylene carbonate, and subsequently cooling to about room temperature, a linear swelling of about 6%, which implies a volumetric swelling of approximately 18%, with no dissolution of the polymer being observed. However, when such a membrane separator is restrained between solid electrodes in a battery, the separator cannot increase in bulk volume. Therefore, swelling occurs within the pores and the pore volume decreases by about 18% of its original bulk volume (FIGS. 1 and 2 hereof). Thus a PVDF battery separator having a volume porosity of 80% is expected to drop to a volume porosity of about 60% when heated to 80° C., causing the battery current density to drop by approximately 25%, thereby reducing the heat generation within the hot area of the battery. Membranes of polystyrene and of acrylonitrile-butadiene-styrene terpolymer are expected to be cross-linked with the addition of benzoyl peroxide to give similar improvements in durability in the solvents used for battery electrolytes. Microporous membranes of acrylic and methacrylic polymers and copolymers are also expected to be improved by cross-linking. Elastomers based on hydrocarbon polymers and silicone polymers are expected to be improved in a similar manner, and hydrocarbon elastomeric membranes have been made having good porosity.

Batteries made with cross-linked microporous separators in accordance with embodiments of this invention are therefore expected to provide a significant measure of safety against overheating and fires, and to allow for continued usage of batteries that experience only local overheating, by reducing the effects of local dendrites or particulate contaminants that may cause hot spots in the battery. Electronic or thermal controls on such batteries may detect these operational changes (by measuring the reduction in the battery current, or from higher battery temperature) to provide instrumental warning of an impending problem that needs to be addressed. This may be an advantage over some of the polyolefin battery separators which claim to possess shut-down features when overheated. Complete battery shut-down in an all-electric vehicle is comparable to running out of fuel without a gas gauge to provide warning, but a measured decrease in current density for a battery using embodiments of the present separator may permit the driver to complete his or her trip (perhaps, at a slower speed) or to the garage for a diagnosis.

Solubility of a polymer in an electrolyte is a function of the Hildebrand or Hansen solubility parameters of the polymer and of the electrolyte, and of the molal volume of the electrolyte. If the solubility parameters are close, a thermoplastic polymer may be soluble in the electrolyte. However, as stated hereinabove, if the same polymer is cross-linked, it will swell in the electrolyte rather than dissolving. At high temperatures, the melting point of the polymer is also of concern, with dissolution occurring more easily or quickly as it nears the normal melting temperature, but cross-linked polymers do not melt.

Having generally described the invention, the following EXAMPLES provide additional details:

### EXAMPLE 1

Microporous membranes were made following the method set forth in the '732 patent, supra, using a mixture of PVDF polymers, KYNAR 301F and 761 (homopolymers of polyvinylidene fluoride), and KYNAR 2801 (a vinylidene fluoride-hexafluoropropylene copolymer). About 4 g of KYNAR 301 F; about 1 g of KYNAR 761; and about 1 g of KYNAR 2801, were dissolved in a mixture of about 116 ml of acetone; approximately 3.5 ml of water; and dicyandiamide in parts per hundred resin set forth in TABLE 1. The mixture was heated in a pressure chamber to approximately 50° C. and spread using a drawdown bar with a gap of 0.38 mm onto a releasing substrate. When cooled, the membrane was shown to have porosity in the range of 60 to 78 volume percent, and to have an air flow in the range of 5 to 14 cm/min·torr. Membranes were heated in an oven to the temperature and time noted in TABLE 1, and dissolution temperatures were measuring in a stirred bath of propylene carbonate with the membranes held by two concentric embroidery hoops, the outer hoop generating a spring pressure on the membrane.

Solvent durability of the fluoropolymers to a solvent solution of the polymer in propylene carbonate was observed to improve significantly from the addition of dicyandiamide (cyanoguanidine, CAS #461-58-5), as may be observed from the TABLE. The hot, swollen cross-linked membranes were noted to have physical durability and coherence, in contrast to the resulting gels from non-crosslinked membranes.

TABLE
PVDF Membranes

| | | | | Dissolution |
|---|---|---|---|---|
| | | Heating | | temperature in |
| | Dicyandiamide | temperature, | Heating | propylene |
| Formula # | Conc. Phr | ° C. | time; min. | carbonate, ° C. |
| A | 0 | | | <60 |
| B | 5 | 66 | 5 | 70 |
| C | 5 | 163 | 30 | 85 |
| D | 16.7 | 163 | 30 | 85 |

The thickness of membrane C was measured to increase from 21.6 μm (when dry) to 22.9 μm after heating to 80° C. in propylene carbonate with subsequent cooling, a linear swelling of about 6%, which implies a volumetric swelling of 18%. As stated hereinabove, when such a membrane separator is restrained between solid electrodes in a battery, the separator cannot increase in bulk volume, and swelling occurs within the pores and decreases the pore volume of 18% of the original bulk volume. Thus, a PVDF battery separator made with 80% volume porosity is expected to drop to about 60% porosity when heated to 80° C. This is expected to cause current density to drop by 25%. Gel electrolytes are known to have higher impedance than liquid electrolytes, and such decrease in current density (a combination of polymer swelling and gelling of the solvent) to provide a self-regulating feature improves the safety of lithium ion batteries. (See, e.g., “Characterisation And Modelling Of Lithium-Ion Battery Electrolytes,” Doctoral Thesis by Peter Georen, www.dissertations.se/dissertation/8b12ba4737/, wherein the electrical conductivity of gelled and liquid electrolytes was studied, and showed an effect on the physical diffusivity of the solvent in each; that is, the conductivity of a lithium perchlorate solution in propylene carbonate was about 5 times greater than that of the same concentration in propylene carbonate gelled with 20% polymethyl methacrylate.).

The amine groups of the dicyandiamide are expected to either extend the chains of the PVDF molecules or to cross-link these molecules. Other diamides and polyamines are expected to provide similar improvements (for example, urea: CAS #57-13-6; p-phenylenediamine: CAS #106-550-3; and melamine: CAS #108-78-1). The addition of magnesium oxide plus any of these cross-linking compositions is expected to further facilitate cross-linking by removing fluorine atoms from the polymer, generating more reactive sites on the chain. Extracting the bi-product magnesium fluoride would be advantageous before placement of the resulting membranes into batteries. Cross-linking of fluoroplastics by radiation is another known process that is expected to improve the high temperature durability and durability of these separators at high temperature.

### EXAMPLE 2

The solvent durability of polysulfone (CAS #25154-01-2) was also improved significantly by addition of a cross-linking chemical such as benzoyl peroxide to solutions of this polymer. Microporous membranes were made by the pre-gel method described hereinabove. A formulation including about 14 g of BASF Ultrason S6010; about 126 ml of dichloromethane; approximately 23 ml of tetrachloroethylene; about 0.5 g of benzoyl peroxide; and approximately 5.7 g of silica aerogel was applied to a release film with a drawdown blade having a gap of 75 μm. After drying, the membrane was baked at about 163° C. for about 30 min. to permit cross-linking of the polymer by the peroxide. This membrane had a dissolution temperature in propylene carbonate of about 88° C., in contrast to a similar membrane which was not reacted with benzoyl peroxide, and which dissolved at 72° C. An improvement in polysulfone durability has also been seen with the addition of dicyandiamide. Microporous polysulfone membranes have been made with durability up to 130° C. in propylene carbonate with such cross-linkers.

The EXAMPLES set forth hereinabove confirm that cross-linking and swelling can be achieved effectively and economically. The optimum for such cross-linking has not yet been identified for any of the polymer/electrolyte systems. Higher cross-linking density can increase strength and survival temperature of the membrane, but may decrease the amount of swelling. The optimum reaction temperatures and reaction times have not yet been identified. These are expected to be a function of reactants and polymers employed. As stated hereinabove, other peroxides and other reactive chemicals may be used for cross-linking, as may radiation methods.

When peroxides are used for the cross-linking, there are often residual compositions that may need to be baked out of the membrane. The porosity of the membrane may be of assistance for this process, in contrast to the extended baking times at 230° C. which are used for removing residual benzoic acid from molded and cured silicone rubber products. However, there are a number of commercially available peroxides which have lower decomposition temperatures, and more volatile bi-products.

The separator membranes of the present invention may include reinforcing fibers (continuous or discrete) and fillers to reduce cost of the product, but allowing cross-linking and thermal protection. Mineral fibers such as glass, wollastonite, and organic fibers, such as polyesters and polyolefins can be effective in adding strength; mineral fillers, such as silica, titania and alumina may decrease material cost of separator membranes. Additionally, separator membranes may be cast directly onto electrodes and cross-linked in place, which avoids the requirement for strong membranes.

Small quantities of the cross-linked polymers of embodiments of the present invention may be coated onto existing stretched polyolefin separators to provide an increased measure of safety to batteries made with these materials.

Separator membranes may be stretched to increase linear or biaxial orientation (and to increase strength) of membranes in addition to cross-linking processes. Such molecular orientation is accomplished by heating the membrane to a temperature below its melting temperature, and quickly stretching the polymer. Cross-linking may then be accomplished by holding the membrane at the reaction temperature. Radiation cross-linking may be also be achieved with the oriented polymer in the same production line.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A microporous lithium ion battery electrode separator comprising: a cross-linked polymer capable of swelling without dissolving, at least 1% by volume when unrestrained and exposed to battery electrolyte at temperatures above the normal operating temperature of said battery.

2. The separator of claim 1, wherein the polymer is chosen from polyvinylidene fluoride, polysulfone, polystyrene, acrylic polymers, methacrylic polymers, acrylonitrile-butadiene-styrene terpolymers, and copolymers thereof.

3. The separator of claim 2, wherein copolymers of polyvinylidene fluoride are chosen from vinylidene and hexafluoropropylene.

4. The separator of claim 2, where copolymers of polysulfone are chosen from polyether sulfones, polyphenyl sulfones, acrylic-styrene copolymers, butadiene-styrene copolymers, and thermoplastic elastomers.

5. The separator of claim 1, wherein the polymer comprises continuous or discontinuous fibers disposed therein.

6. The separator of claim 5, wherein the fibers comprise mineral fibers.

7. The separator of claim 6, wherein the mineral fibers are chosen from wollastonite and glass.

8. The separator of claim 5, wherein the fibers comprise organic fibers.

9. The separator of claim 8, wherein the organic fibers are chosen from polyesters and polyolefins.

10. The separator of claim 1, wherein the polymer comprises fillers.

11. The separator of claim 10, wherein the fillers are chosen from silica, titania and alumina.

12. The separator of claim 1, wherein the polymer is stretch-oriented at a temperature below the melting temperature of the polymer.

13. The separator of claim 1, wherein the battery electrolyte comprises propylene carbonate and mixtures of propylene carbonate with other carbonates.

14. The separator of claim 1, wherein the polymer is formed on a substrate.

15. The separator of claim 14, wherein the substrate comprises a battery electrode.

16. A method for generating a battery electrode separator membrane, comprising the steps of:
forming a solution of a fluoropolymer or fluoropolymer copolymer, a solvent for the fluoropolymer or fluoropolymer copolymer, a miscible non-solvent for the fluoropolymer or fluoropolymer copolymer; and cross-linking composition;
casting the solution onto a substrate;
removing the non-solvent and solvent such that a microporous polymer is generated; and
heating the microporous polymer such that cross-linking takes place.

17. The method of claim 16, wherein the cross-linking compositions are chosen from dicyandiamide, urea, p-phenylenediamine, and melamine.

18. The method of claim 16, further comprising the step mixing magnesium oxide with the solution.

19. The method of claim 18, further comprising the step of removing magnesium fluoride from the cross-linked microporous polymer.

20. The method of claim 16, wherein the fluoropolymer comprises polyvinylidene fluoride.

21. The method of claim 20, wherein polyvinylidene fluoride copolymers are chosen from vinylidene and hexafluoropropylene.

22. The method of claim 16, wherein the substrate comprises a battery electrode.

23. The method of claim 16, wherein the solvent comprises acetone and the non-solvent comprises water.

24. The method of claim 16, further comprising the step of mixing continuous or discontinuous fibers with the solution.

25. The method of claim 24, wherein the fibers comprise mineral fibers.

26. The method of claim 25, wherein the mineral fibers are chosen from wollastonite and glass.

27. The method of claim 24, wherein the fibers comprise organic fibers.

28. The method of claim 27, wherein the organic fibers are chosen from polyesters and polyolefins.

29. The method of claim 16, further comprising the step of mixing fillers with the solution.

30. The separator of claim 29, wherein the fillers are chosen from silica, titania and alumina.
